(19) United States
(12) Patent Application Publication
(10) Pub. No.: US 2013/0127417 A1
(43) Pub. Date: May 23, 2013

(54) CONTROL SYSTEM FOR ELECTRIC VEHICLE CHARGING STATIONS AND METHOD OF USING THE SAME

(71) Applicant: Electric Transportation Engineering Corporation, d/b/a ECOtality North America, Phoenix, AZ (US)

(72) Inventors: Donald B. Karner, Phoenix, AZ (US); Kevin P. Morrow, Mesa, AZ (US)

(73) Assignee: Electric Transportation Engineering Corporation, d/b/a ECOtality North America, Phoenix, AZ (US)

(21) Appl. No.: 13/713,876

(22) Filed: Dec. 13, 2012

Related U.S. Application Data
(63) Continuation of application No. PCT/US2011/034667, filed on Apr. 29, 2011.
Application No. PCT/US2011/034667 is a continuation of application No. PCT/US2011/037587, filed on May 23, 2011.
Application No. PCT/US2011/037587 is a continuation of application No. PCT/US2011/037588, filed on May 23, 2011.
Application No. PCT/US2011/037588 is a continuation of application No. PCT/US2011/037590, filed on May 23, 2011.
Application No. PCT/US2011/037587 is a continuation of application No. PCT/US2011/034667, filed on Apr. 29, 2011.
Application No. PCT/US2011/037588 is a continuation of application No. PCT/US2011/034667, filed on Apr. 29, 2011.
Application No. PCT/US2011/037590 is a continuation of application No. PCT/US2011/034667, filed on Apr. 29, 2011.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.

(51) Int. Cl. B60L 11/18

(52) U.S. Cl. CPC B60L 11/1824
USPC 320/109; 320/137

(57) ABSTRACT

Some embodiments include a control system for electric vehicle charging stations and method of using the same as disclosed herein. Other embodiments of related systems and methods are also disclosed.

### CROSS-REFERENCE TO RELATED APPLICATIONS

This application is a continuation of: (a) International Patent Application Serial No. PCT/US2011/034667, filed Apr. 29, 2011, (b) International Patent Application Serial No. PCT/US2011/037587, filed May 23, 2011, (c) International Patent Application Serial No. PCT/US2011/037588, filed May 23, 2011, and (d) International Patent Application Serial No. PCT/US2011/037590, filed May 23, 2011. International Patent Application Serial No. PCT/US2011/034667, International Patent Application Serial No. PCT/US2011/037587, International Patent Application Serial No. PCT/US2011/037588, and International Patent Application Serial No. PCT/US2011/037590 each claim the benefit of: (1) U.S. Provisional Application Ser. No. 61/367,316, filed Jul. 23, 2010; (2) U.S. Provisional Application Ser. No. 61/367,321, filed Jul. 23, 2010; (3) U.S. Provisional Application Ser. No. 61/367,337, filed Jul. 23, 2010; and (4) U.S. Provisional Application Ser. No. 61/367,317, filed Jul. 23, 2010. Further, International Patent Application Serial No. PCT/US2011/037587, International Patent Application Serial No. PCT/US2011/037588, and International Patent Application Serial No. PCT/US2011/037590 each are a continuation of International Patent Application Serial No. PCT/US2011/034667. The disclosures of U.S. Provisional Application Ser. No. 61/367,316; U.S. Provisional Application Ser. No. 61/367,321; U.S. Provisional Application Ser. No. 61/367,337; U.S. Provisional Application Ser. No. 61/367,317; International Patent Application Serial No. PCT/US2011/034667, International Patent Application Serial No. PCT/US2011/037587, International Patent Application Serial No. PCT/US2011/037588, and International Patent Application Serial No. PCT/US2011/037590 are incorporated herein by reference in their entirety.

### RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to control systems for electric vehicle charging stations, and relates more particularly to such systems that provide optimized charging of rechargeable energy storage systems of electric vehicles and methods of using the same.

### DESCRIPTION OF THE BACKGROUND

Providing electricity to electric vehicles propelled at least in part by rechargeable energy storage systems is a substantially more complicated and time-consuming process than refueling vehicles propelled solely by internal combustion engines. The cost and time requirements of providing electricity to such rechargeable energy storage systems of electric vehicles can fluctuate dramatically based on changes in electricity cost and demand through the duration of the electricity transfer. Likewise, the substantially longer durations of time required to provide electricity to the rechargeable energy storage systems in comparison to refueling internal combustion systems also make the availability of electric vehicle charging stations of greater concern than for traditional petroleum-based refueling stations. Furthermore, the use of alternative energy sources to provide electricity is becoming increasingly important in the pursuit to limit world-wide dependence on fossil fuels.

Accordingly, a need or potential for benefit exists for an apparatus or system that allows a user increased control over electric vehicle charging stations in order to permit the user to customize electricity transfers to fit his or her personal needs and to account for the above factors as well as other factors that complicate providing electricity to rechargeable energy storage systems of electric vehicles.

### BRIEF DESCRIPTION OF THE DRAWINGS

To facilitate further description of the embodiments, the following drawings are provided in which:

FIG. 1 illustrates an exemplary control system for an electric vehicle charging station to charge a rechargeable energy storage system, according to one embodiment;

FIG. 2 illustrates a flow chart illustrating a method for operating an electric vehicle charging station configured to communicate with at least one computer database, according to one embodiment;

FIG. 3 is a block diagram illustrating a control system for an electric vehicle charging station to charge a rechargeable energy storage system, according to one embodiment;

FIG. 4 illustrates a computer that is suitable for implementing an embodiment of computer system of FIG. 3;

FIG. 5 is a block diagram illustrating an example of the elements included in the circuit boards inside the chassis of the computer system of FIG. 3; and

FIG. 6 is a flow chart illustrating a method for operating an electric vehicle charging station to charge a rechargeable energy storage system, according to one embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

### DETAILED DESCRIPTION OF EXAMPLES OF EMBODIMENTS

Some embodiments include a system for charging a rechargeable energy storage system of an electric vehicle. The system comprises an electric vehicle charging station configured to make available electricity to charge the rechargeable energy storage system of the electric vehicle. Further, the system comprises a user interface configured to receive a charging mode and a charging characteristic and to communicate with the electric vehicle charging station in order to operate the electric vehicle charging station. Meanwhile, the system comprises a data acquisition module configured to communicate with the user interface and to receive charging parameter data, and a control module configured (a) to communicate with the user interface and the data acquisition module, (b) to receive the charging mode, the charging characteristic, and the charging parameter data, (c) to monitor in real time the charging parameter data, and (d) based on the charging parameter data, to control when the electric vehicle charging station makes available the electricity to charge the rechargeable energy storage system in order to achieve the charging mode in view of the charging characteristic. The charging mode can comprise a day and time by which to complete charging the rechargeable energy storage system. Further, the charging characteristic can comprise at least one of a request to provide a fastest charge, a request to provide a cheapest charge, or a request to provide an environmentally cleanest charge. Further still, the charging parameter data can comprise at least one of energy and demand data for one or more electric grids configured to provide the electricity to the electric vehicle charging station, alternative energy resource data, or availability of the electric vehicle charging station data.

Various embodiments include a system for charging a rechargeable energy storage system of an electric vehicle. The system comprises an input module configured to receive a charging mode and a charging characteristic and to communicate with an electric vehicle charging station in order to operate the electric vehicle charging station. The electric vehicle charging station can be configured to make available electricity to charge the rechargeable energy storage system of the electric vehicle. Meanwhile, the system comprises a data acquisition module configured to communicate with the input module and to receive charging parameter data. Further, the system comprises a control module configured (a) to communicate with the input module and the data acquisition module, (b) to receive the charging mode, the charging characteristic, and the charging parameter data, (c) to monitor in real time the charging parameter data, and (d) based on the charging parameter data, to control when the electric vehicle charging station makes available the electricity to charge the rechargeable energy storage system in order to achieve the charging mode in view of the charging characteristic. The charging mode can comprise a day and time by which to complete charging the rechargeable energy storage system. The charging characteristic can comprise at least one of a request to provide a fastest charge, a request to provide a cheapest charge, or a request to provide an environmentally cleanest charge. Also, the charging parameter data can comprises at least one of energy and demand data for one or more electric grids configured to provide the electricity to the electric vehicle charging station, alternative energy resource data, or availability of the electric vehicle charging station data. Meanwhile, the input module can be configured to receive the charging mode and the charging characteristic from at least one of a user of the electric vehicle charging station or a user profile of the user, at least one of the electric vehicle charging station or the input module can comprise the control module, and at least one of the electric vehicle charging station or the input module can comprise the data acquisition module. Further, the data acquisition module can be configured to receive the charging parameter data in real time via communication with a computer system comprising at least one computer database, the at least one computer database can comprise the charging parameter data, and the computer system can be located remotely from the electric vehicle charging station.

Further embodiments include a method of making electricity available to charge a rechargeable energy storage system of an electric vehicle by using an electric vehicle charging station, at least part of the method being implemented via execution of computer instructions configured to run at one or more computer processing modules and configured to be stored in one or more non-transitory computer memory storage modules, the method can comprise receiving a charging mode and a charging characteristic. The charging mode can comprise a day and time by which to complete charging the rechargeable energy storage system; and the charging characteristic can comprise at least one of a request to provide a fastest charge, a request to provide a cheapest charge, and a request to provide an environmentally cleanest charge. Also, the method can comprise: receiving charging parameter data in real time, the charging parameter data comprising at least one of energy and demand data for one or more electric grids configured to provide the electricity to the electric vehicle charging station, alternative energy resource data, and availability of the electric vehicle charging station data; monitoring in real time the charging parameter data; and based on the charging parameter data, controlling when the electric vehicle charging station makes available the electricity from the electric vehicle charging station to charge the rechargeable energy storage system in order to achieve the charging mode in view of the charging characteristic.

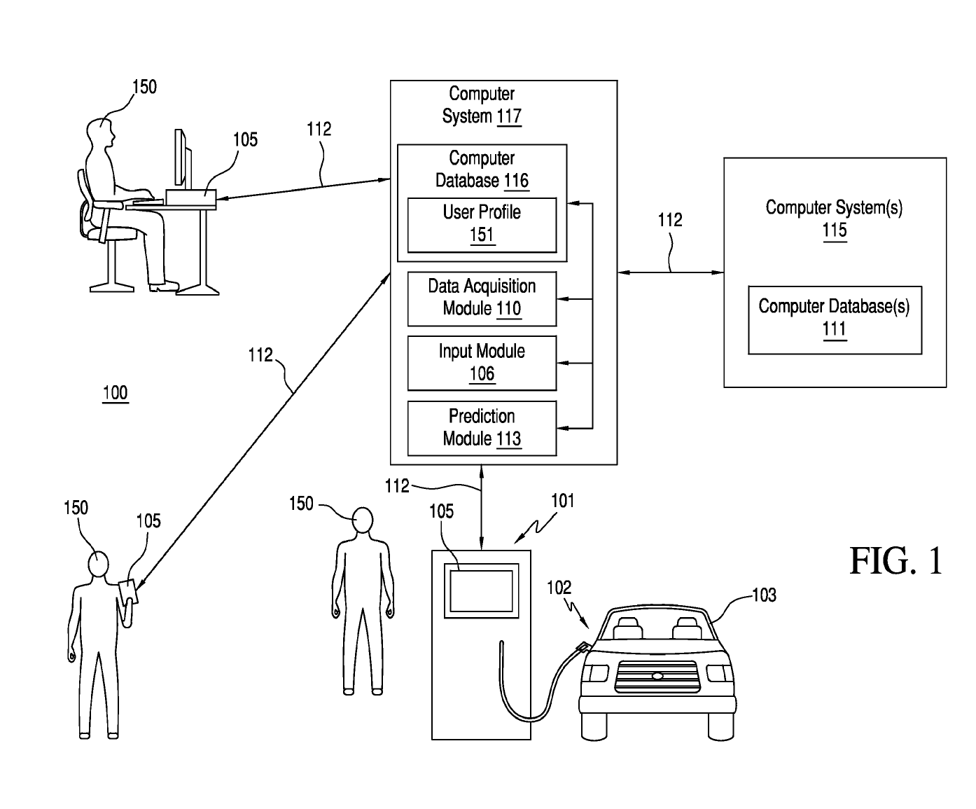

Turning to the drawings, FIG. 1 illustrates control system 100 for an electric vehicle charging station 101 to charge a rechargeable energy storage system 102 (not shown), according to an embodiment of control system 100. Control system 100 is merely exemplary and is not limited to the embodiments presented herein. Control system 100 can be employed in many different embodiments or examples not specifically depicted or described herein.

In many embodiments, any single module/sub-module or combination of modules/sub-modules of control system 100 can comprise hardware and/or software. In the same or different embodiments, where any single module/sub-module or combination of modules/sub-modules of control system 100 comprises hardware and/or software, that module or those modules of control system 100 can further be combined with an additional module/sub-module or multiple modules/sub-modules of hardware and/or software of a system other than control system 100.

In many embodiments, any single module/sub-module or combination of modules/sub-modules of control system 100 can be configured to communicate with any other single module/sub-module or combination of modules/sub-modules of control system 100. In the same or different embodiments, where any single module/sub-module or combination of modules/sub-modules of control system 100 is configured to communicate with any other single module/sub-module or combination of modules/sub-modules of control system 100, communication can comprise passing information between the any single module/sub-module or combination of modules/sub-modules of control system 100 and the any other single module/sub-module or combination of modules/sub-modules of control system 100.

In many embodiments, control system 100 can be configured to operate in real time. In the same or different embodiments, at least one module and/or sub-module in control system 100 can be configured to perform an operation upon the occurrence of an operation by at least one of or a combination of the other modules of control system 100. In the same or different embodiments, at least one module and/or sub-module in control system 100 can be configured to perform an operation upon the occurrence of an operation by a combination of the other modules of control system 100 when the other modules operate in a specified sequence. In still other embodiments, at least one module and/or sub-module in control system 100 can be configured to operate upon the passage of a certain interval of time.

In some embodiments, control system 100 can comprise a public system. In many embodiments, where control system 100 comprises a public system, control system 100 can comprise at least one of a government public system or a commercial public system (including a non-profit public system). In some embodiments, where control system 100 comprises a public system, control system 100 can be operated for free or for a fee. In other embodiments, control system 100 can comprise a private system. In many embodiments, where control system 100 comprises a private system, control system 100 can comprise at least one of a domestic private system or a commercial private system (including a non-profit private system). In various embodiments, where control system 100 comprises at least one of a domestic private system or a commercial private system, control system 100 can be privately leased or owned.

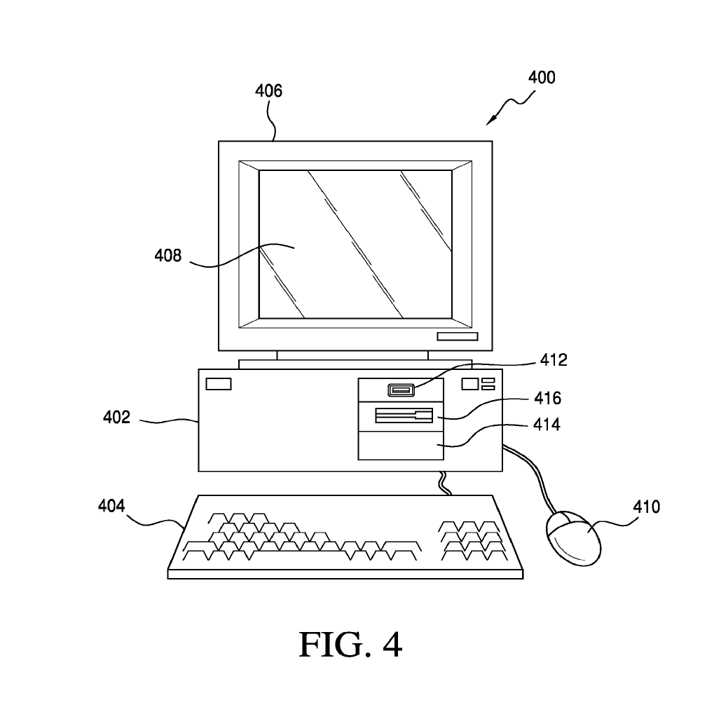

In some embodiments, at least part of control system 100 can be implemented with a computer system similar to computer system 400 (FIG. 4), as described in further detail below.

Referring now to FIG. 1, control system 100 comprises user interface 105 configured to permit user 150 of electric vehicle charging station 101 to communicate with electric vehicle charging station 101 to make available a quantity of the electricity passing between electric vehicle charging station 101 and rechargeable energy storage system 102 and/or a direction (i.e., supplying and/or receiving electricity) of the electricity passing between electric vehicle charging station 101 and rechargeable energy storage system 102.

In some embodiments, when electric vehicle charging station 101 makes available the quantity of the electricity passing between electric vehicle charging station 101 and rechargeable energy storage system 102 and/or the direction of the electricity passing between electric vehicle charging station 101 and rechargeable energy storage system 102, rechargeable energy storage system 102 and/or vehicle 103, as described below, can be configured to control a flow rate or electric power level of the electricity passing between electric vehicle charging station 101 and rechargeable energy storage system 102 (e.g., where electric vehicle charging station 101 comprises a level 2 electric vehicle supply equipment, as described below). In other embodiments, when electric vehicle charging station 101 makes available the quantity of the electricity passing between electric vehicle charging station 101 and rechargeable energy storage system 102 and/or the direction of the electricity passing between electric vehicle charging station 101 and rechargeable energy storage system 102, electronic vehicle charging station 101 can be configured to control the flow rate or electric power level of the electricity passing between electric vehicle charging station 101 and rechargeable energy storage system 102 (e.g., where electric vehicle charging station 101 comprises a level 3 electric vehicle supply equipment, as described below).

In some embodiments, user interface 105 can comprise a personal computer, a mobile device (e.g., smart phone), and/or a terminal (e.g., at or near to electric vehicle charging station 101) comprising one or more displays (e.g., a touch screen display) and/or one or more input mechanisms (e.g., keyboard, touch screen, keypad, voice recognition, magnetic card reader, barcode reader, wireless networking device(s) (e.g., modems and/or radio frequency identification readers, etc.), and/or wired networking devices, etc.). User interface 105 can be configured to receive inputs from and/or provide outputs to user 150 to facilitate control of electric vehicle charging station 101. In the same or different embodiments, user interface 105 can comprise and/or be implemented as a computer system similar to computer system 400 (FIG. 4), as described in further detail below, to perform at least some of the functions of user interface 105.

In some embodiments, user 150 can comprise multiple users. In the same or different embodiments, user 150 can comprise a user of one or more vehicle(s) 103. In the same or different embodiments, the vehicle(s) 103 can comprise at least one of a car, a truck, a motorcycle, a bicycle, a scooter, a boat, a train, an aircraft, an airport ground support equipment, and/or a material handling equipment (e.g., a fork-lift), etc. In many embodiments, vehicle(s) 103 can comprise an electric vehicle and/or any other grid-connected vehicle.

In many embodiments, electric vehicle charging station 101 can be configured to operate as part of a charging network. The charging network can comprise multiple electric vehicle charging stations similar to electric vehicle charging station 101. In the same or different embodiments, each electric vehicle charging station can be configured to communicate with any of the other electric vehicle charging stations of the charging network. In another embodiment, each electric vehicle charging station can be configured to not be in communication with the other electric vehicle charging stations of the charging network. In many embodiments, user(s) 150 can become members of the charging network. In some embodiments, when user(s) 150 become members, user(s) 150 can establish user profile 151, as described in further detail below, to streamline the interactions of user(s) 150 with electric vehicle charging station 101 and/or to obtain preference over non-members for use of the charging network and/or for energy use during high demand periods. In the same or different embodiments, user(s) 150 can become members of the charging network by providing a one-time and/or a recurring fee or, in some examples, at no cost.

In various embodiments, electric vehicle charging station 101 can comprise an electric vehicle supply equipment (e.g., a device for providing electricity to a rechargeable energy storage system (e.g., rechargeable energy storage system 102) of an electric vehicle (e.g., vehicle 103)). In other embodiments, electric vehicle charging station 101 can comprise an industrial electric charger (e.g., an on-board AC electric charger, a off-board DC electric charger). In still other embodiments, electric vehicle charging station 101 can be configured to transfer electricity to rechargeable energy storage system 102 of vehicle 103 via electrical induction. Electric vehicle charging station 101 can comprise either of a stand-alone unit or a wall-mounted unit.

In various embodiments, the electric vehicle supply equipment can comprise a level 1 electric vehicle supply equipment, a level 2 electric vehicle supply equipment, and/or a level 3 electric vehicle supply equipment. The level 1 electric vehicle supply equipment can comprise either of a level 1 alternating current (AC) electric vehicle supply equipment or a level 1 direct current (DC) electric vehicle supply equipment. Meanwhile, the level 2 electric vehicle supply equipment can comprise either of a level 2 AC electric vehicle supply equipment or a level 2 DC electric vehicle supply equipment. Furthermore, the level 3 electric vehicle supply equipment can comprise either of a level 3 AC electric vehicle supply equipment or a level 3 DC electric vehicle supply equipment. In some embodiments, the level 2 electric vehicle supply equipment and/or the level 3 electric vehicle supply equipment can also be referred to as a fast charger. In many embodiments, the electric vehicle supply equipment can make available electricity comprising a maximum electric current of 30 amperes (A) or 48 A. When the maximum electric current of the electric vehicle supply equipment comprises 30 A, the electric vehicle supply equipment can be configured to make available electricity comprising an electric current of one or more of 12 A, 16 A, or 24 A. When the maximum electric current of the electric vehicle supply equipment comprises 48 A, the electric vehicle supply equipment can be configured to make available electricity comprising an electric current of one or more of 12 A, 16 A, 24 A, or 30 A.

For example, the level 1 AC electric vehicle supply equipment can make available electricity comprising an electric voltage of approximately 120 volts (V) and an electric current: greater than or equal to approximately 0 amperes (A) and less than or equal to approximately 12 A AC, when employing a 15 A breaker, or (b) greater than or equal to approximately 0 A and less than or equal to approximately 16 A AC, when employing a 20 A breaker. Accordingly, the level 1 electric vehicle supply equipment can comprise a standard grounded domestic electrical outlet. Meanwhile, the level 2 AC electric vehicle supply equipment can make available electricity comprising an electric voltage greater than or equal to approximately 208 V and less than or equal to approximately 240 V and an electric current greater than or equal to approximately 0 A and less than or equal to approximately 80 A AC. Furthermore, a level 3 electric vehicle supply equipment can make available electricity comprising an electric voltage greater than or equal to approximately 208 V and an electric current greater than or equal to approximately 80 A AC (e.g., 240 V AC (single phase), 208 V AC (triple phase), 480 V AC (triple phase). In some embodiments, the electric voltages for the level 1 electric vehicle supply equipment, the level 2 electric vehicle supply equipment, and/or the level 3 electric vehicle supply equipment can be within plus or minus (±) ten percent (%) tolerances of the electric voltages provided above.

In other examples, the level 1 DC electric vehicle supply equipment can provide electric power greater than or equal to approximately 0 kiloWatts (kW) and less than or equal to approximately 19 kW. Meanwhile, the level 2 DC electric vehicle supply equipment can provide electric power greater than or equal to approximately 19 kW and less than or equal to approximately 90 kW. Furthermore, level 3 electric vehicle supply equipment can provide electric power greater than or equal to approximately 90 kW. In some embodiments, the term fast charger can refer to an electric vehicle supply equipment providing electricity comprising an electric voltage between approximately 300 V-500 V and an electric current between approximately 100 A-400 A DC.

The industrial electric charger (e.g., the on-board AC electric charger, the off-board DC electric charger) can provide electric power greater than or equal to approximately 3 kW and less than or equal to approximately 33 kW. The off-board DC electric charger can provide electricity comprising an electric voltage greater than or equal to approximately 18 V DC and less than or equal to approximately 120 V DC.

In many embodiments, electric vehicle charging station 101 can comprise at least one electrical connector each being coupled to the electric vehicle charging station via an electric cable. In many embodiments, the electrical connector(s) can comprise a J1772 standard electrical connector. In other embodiments, the electrical connector(s) can comprise an IEC 62196 electrical connector. In various embodiments, the electrical connector(s) can comprise a JARI Level 3 DC electrical connector. In many embodiments, the electric cable can be one of approximately 10, 12, 14, 16, 18, or 20 feet (3.1, 3.7, 4.3, 4.9, 5.5, or 6.1 meters) in length. Where the charging station has more than one electrical connector, the electric vehicle charging station can provide and/or receive electricity to and/or from: (a) multiple vehicles simultaneously; and/or (b) a second vehicle via a second electrical connector while first vehicle 103 is coupled to a first electrical connector, but is not currently receiving a charge therefrom.

In further embodiments, electric vehicle charging station 101 can comprise a rechargeable energy storage system exchange station. In various embodiments, electric vehicle charging station 101 can comprise a gaseous or liquid fuel dispensing system. In other embodiments, electric vehicle charging station 101 can be configured for wireless energy transfer (e.g., charging). Wireless energy transfer can comprise inductive, microwave, or other non-conductive forms of energy transfer.

In some embodiments, electric vehicle charging station 101 can be coupled to an electric grid and receive electricity from a remote location. In other embodiments, electric vehicle charging station 101 can generate electricity at and/or near electric vehicle charging station 101 using at least one of solar energy generation, wind energy generation (e.g., turbines), tidal energy generation, hydroelectric energy generation, or any other suitable source of renewable energy.

In many embodiments, electric vehicle charging station 101 can be configured to comply with the International Organization for Standardization (ISO) standards for safety (e.g., ISO 6469). In various embodiments, electric vehicle charging station 101 can comprise an automatic shutoff feature for emergencies. In further embodiments, electric vehicle charging station 101 can incorporate insulating materials to prevent contact with electrically conductive components of electric vehicle charging station 101.

In some embodiments, electric vehicle charging station 101 can comprise an electricity meter. In the same or different embodiments, the electricity meter can be configured to measure the amount of energy transferred: (a) from electric vehicle charging station 101 to rechargeable energy storage system 102; or (b) from electric vehicle charging station 102 to rechargeable energy storage system 102. In the same or different embodiments, the electricity meter can be a part of and configured to communicate with electric vehicle charging station 101. In other embodiments, the electricity meter can be separate from electric vehicle charging station 101 and configured to communicate with electric vehicle charging station 101. In the same or different embodiments, the electricity meter can comprise a certified energy and demand meter. In the same or different embodiments, the electricity meter can be configured to perform revenue grade electricity metering. In the same or different embodiments, the electricity meter can comprise an electronic electricity meter. In other embodiments, the electricity meter can comprise an electromechanical electricity meter. In many embodiments, the electricity meter can comprise a smart electricity meter. In various embodiments, the electricity meter can comprise a self-contained electricity meter.

In many embodiments, vehicle(s) 103 can each comprise rechargeable energy storage system 102. Rechargeable energy storage system 102 can comprise a device configured to store electricity for vehicle(s) 103. Rechargeable energy storage system 102 can comprise (a) one or more batteries and/or one or more fuel cells, (b) one or more capacitive energy storage systems (e.g., super capacitors such as electric double-layer capacitors), and/or (c) one or more inertial (e.g., flywheel) energy storage systems. In many embodiments, the one or more batteries can comprise one or more rechargeable (e.g., traction) and/or non-rechargeable batteries. For example, the one or more batteries can comprise one or more of a lead-acid battery, a valve regulated lead acid (VRLA) battery such as a gel battery and/or an absorbed glass mat (AGM) battery, a nickel-cadmium (NiCd) battery, a nickel-zinc (NiZn) battery, a nickel metal hydride (NiMH) battery, a zebra (e.g., molten chloroaluminate (NaAlCl₄)) and/or a lithium (e.g., lithium-ion (Li-ion)) battery. In some embodiments, where rechargeable energy storage system 102 comprises more than one battery, the batteries can all comprise the same type of battery. In other embodiments, where rechargeable energy storage system 102 comprises more than one battery, the batteries can comprise at least two types of batteries. In many embodiments, the at least one fuel cell can comprise at least one hydrogen fuel cell.

Referring again to FIG. 1, control system 100 comprises data acquisition module 110 configured to communicate with user interface 105 and to acquire data relating to at least one charging parameter from at least one computer database of one or more computer database(s) 111. Computer database(s) 111 can be stored at one or more memory storage modules of at least one computer system 115. In some embodiments, data acquisition module 110 can be part of electric vehicle charging station 101 and/or user interface 105. Each computer system of computer system(s) 115 can be similar or identical to computer system 400 (FIG. 4), as described in further detail below. The information in computer database 111 can be stored, for example, as part of an XML (Extensible Markup Language) database, a MySQL database, or an Oracle® database. Computer database 111 can hold and/or can store information comprising the data relating to the at least one charging parameter. In some embodiments, computer database(s) 111 can be part of and/or can be separate from control system 100.

In various examples, computer database(s) 111 could be maintained and/or operated by the operator of control system 100, by the operator of the charging network, as described below, by one or more utility companies, and/or by one or more third-party entities (other than the one or more utility companies if any of the utility companies are also third-party entities and not operating control system 100). For example, the one or more third-party entities can comprise one or more companies that aggregate and maintain data pertinent to and/or comprising some or all of the data relating to the at least one charging parameter. For a further example, data acquisition module 110 may acquire the data relating to at least one charging parameter from multiple computer databases of computer database(s) 111 such that some of the data relating to at least one charging parameter is acquired from one or more first computer databases of computer databases 111 (e.g., computer database(s) of the one or more utility companies where the computer database(s) comprise energy and demand data, local transformer distribution data, alternative energy resource data, supplementary load data, etc., as described in more detail below), one or more second computer databases of computer databases 111 (e.g., computer database(s) of the operator of control system 100 where the computer database(s) comprise availability of electric vehicle charging station data, supplementary load data, and/or electric vehicle range history data, etc., as described in more detail below), and/or one or more third computer databases of computer databases 111 (e.g., computer database(s) of the one or more third-party entities where the computer database(s) comprise local transformer distribution data, alternative energy resource data, supplementary load data, and/or electric vehicle range history data, etc., as described in more detail below).

In some embodiments, the one or more electric utility companies may be able to communicate with and/or access any of computer database(s) 111 even where the one or more electric utility companies do not maintain and/or operate computer database(s) 111. Likewise, the one or more electric utility companies may be able to access and/or communicate with computer system 117, computer database 116 and/or user profile 151, each being described in greater detail below. For example, any utility company of the one or more utility companies may be able to provide data to (e.g., energy and demand data, local transformer distribution data, alternative energy resource data, supplementary load data, etc., as described in more detail below) and/or receive data from (e.g., billing and/or usage information, etc.) computer database(s) 111 and/or computer database 116.

Referring again to FIG. 1, in some embodiments, data acquisition module 110 and/or user interface 105 can comprise a connection to a computer network 112 permitting communication with computer system(s) 115, computer database(s) 111, computer system 117, and/or computer database 116. Accordingly, data acquisition module 110 can be configured to acquire the data relating to the at least one charging parameter from the at least one computer database 111 via computer network 112. Meanwhile, user interface 105 can be configured to communicate with computer system 117 to access user profile 151, as described below, via computer network 112. In many embodiments, computer network 112 can comprise a cellular telephone network. In the same or different embodiments, the cellular telephone network can comprise at least one of a code division multiple access (CDMA) (e.g., IS-95) network, a global system for mobile communications (GSM) network, a time division multiple access (TDMA) network, and/or an orthogonal frequency-division multiplexing (OFDM) network, and the like. In some embodiments, the CDMA and/or GSM networks can be configured to operate in 2G, 3G, and/or 4G (e.g., implementing multiple OFDM networks operating with multi-carrier code division multiple access (MC-CDMA) and multiple-input and multiple-output (MIMO) configurations) modalities, and the like. In the same or different embodiments, computer network 112 can comprise a worldwide network, a local area network, a wide area network, a metropolitan area network, and/or a personal area network, or the like. In many embodiments, computer network 112 can operate with one or more frequencies (e.g., 802.11(a), (b), (g), (n)). In some embodiments, computer network 112 can operate via Bluetooth™ and/or ZigBee® wireless protocols, or the like.

In many embodiments, user interface 105 permits user 150 to select one or more charging modes (e.g., a first charging mode, a second charging mode). In various embodiments, a charging mode can comprise one or more requirements pertaining to how electric vehicle charging station 101 charges rechargeable energy storage system 102. In the same or different embodiments, the first charging mode can comprise at least one day and time by which to complete charging rechargeable energy storage system 102, at least one duration of time during which to complete charging rechargeable energy storage system 102, at least one percentage of a maximum charge capacity of rechargeable energy storage system 102 to which to charge rechargeable energy storage system 102, at least one quantity of electricity (e.g., amperage, voltage, and/or wattage, etc.) by which to charge rechargeable energy storage system 102, and/or at least one distance user 150 desires to travel. In many embodiments, user interface 105 comprises a menu configured to permit user 150 to select the first charging mode and/or additional charging modes. In some embodiments, user interface 105 can require user 150 to provide one or more user inputs in order to select the one or more charging modes. For example, user inputs can comprise a present state of charge of rechargeable energy storage system 102, an odometer reading of vehicle 103, an electricity meter read date for the electricity meter of electric vehicle charging station 101, an internal combustion engine comparison miles (kilometers) per gallon (liter) for vehicle 103, the at least one day and time by which to complete charging rechargeable energy storage system 102, the at least one duration of time by which to complete charging rechargeable energy storage system 102, the at least one percentage of a maximum charge capacity of rechargeable energy storage system 102 to which to charge rechargeable energy storage system 102, the at least one quantity of electricity (e.g., amperage, voltage, and/or wattage, etc.) by which to charge rechargeable energy storage system 102, and/or the at least one distance user 150 desires to travel. In many embodiments, user interface 105 comprises a menu configured to permit user 150 to select the first charging mode and/or additional charging modes, or the like.

In various embodiments, control system 100 and/or user interface 105 can comprise input module 106. User interface 105 can be configured to communicate with input module 106. Input module 106 is configured to receive the first charging mode and/or one or more charging characteristics. In some embodiments, input module 106 can be located at and/or part of user interface 105. In other embodiments, input module 106 can be located apart and/or separate from user interface 105 and/or data acquisition module 110 such that user interface 105 and/or data acquisition module 110 communicates with input module 106 remotely. Input module 106 can reference the data relating to the at least one charging parameter in accordance with the charging characteristic to determine if electric vehicle charging station 101 is able to make available the quantity of the electricity and/or the direction of the electricity to achieve the first charging mode selected by user 150. When input module 106 determines that electric vehicle charging station 101 is able to make available the quantity of the electricity and/or the direction of the electricity to achieve the first charging mode selected by user 150, user interface 105 can be configured to command electric vehicle charging station 101 to make available the quantity of the electricity and/or the direction of the electricity that achieves the first charging mode selected by user 150. In some examples, where the charging mode comprises at least one percentage of a maximum charge capacity of rechargeable energy storage system 102 by which to charge rechargeable energy storage system 102 and/or at least one quantity of electricity (e.g., amperage, voltage, and/or wattage, etc.) by which to charge rechargeable energy storage system 102, as described above, user interface 105 can be configured to command electric vehicle charging station 101 to make available the quantity of the electricity and/or the direction of the electricity that achieves the first charging mode selected by user 150 in a manner similar to that described in U.S. Pat. No. 5,548,200, which is incorporated herein by reference. In the same or different embodiments, when input module 106 determines that electric vehicle charging station 101 is not able to make available the quantity of the electricity and/or the direction of the electricity to achieve the first charging mode selected by user 150, user interface 105 instructs the user to provide a second charging mode. In some embodiments, input module 106 can be configured to make available the electricity to pass between electric vehicle charging station 101 and rechargeable energy storage system 102, in which case input module 106 can make available the quantity of the electricity and/or the direction of the electricity to achieve the first charging mode selected by user 150, as opposed to user interface 105.

In many embodiments, the charging characteristic can comprise a manner in which to achieve the one or more requirements of the charging mode. For example, in some embodiments, the charging characteristic comprises one or more of a request to provide a fastest charge, a request to provide a cheapest charge, and/or a request to provide an environmentally cleanest charge. In further embodiments, the charging characteristic further comprises one or more of a request to charge within a range of energy cost rates, a request to charge outside of one or more energy demand periods, a request to give preference to one or more additional loads (e.g., appliances) drawing electricity from a same one or more electric grids as electric vehicle charging station 101, and/or a request not to charge rechargeable energy storage system 102 when certain of the one or more additional loads (e.g., washing machine, dryer, oven, air conditioner, etc.) are simultaneously drawing electricity from the one or more electric grids. In further embodiments, user interface 105 permits user 150 to select the charging characteristic from a menu of options. In the same or different embodiments, user interface 105 permits user 150 to rank the one or more of the request to provide the fastest charge, the request to provide the cheapest charge, and/or the request to provide the environmentally cleanest charge by a particular order. For example, if user 150 selects the charging characteristic comprising fastest charge and environmentally cleanest charge and then proceeds to rank them in the order of first and second, respectively, input module 106 can determine the manner in which to provide the fastest clean charge possible, but if a faster charge is available using a non-clean energy source, input module 106 will defer to that option for charging rechargeable energy storage system 102. In other embodiments, user interface 105 determines the charging characteristic based on the data relating to the at least one charging parameter. For example, if input module 106 determines from the data relating to the at least one charging parameter that any cost savings from charging rechargeable energy storage system 102 according to one strategy would be negligible compared to any other available strategy, input module 106 may select the charging characteristic comprising fastest and/or environmentally cleanest to provide a more advantageous charging characteristic for user 150 because the charging mode comprising cheapest would not add substantial benefit to user 150.

In some embodiments, the data relating to the at least one charging parameter can comprise energy and demand data for one or more electric grids configured to provide the electricity to the electric vehicle charging station, local transformer distribution data, alternative energy resource data, availability of electric vehicle charging station data, supplementary load data, and/or electric vehicle range history data. In some embodiments, energy and demand data can comprise past/present/future electricity prices/values (e.g., energy pricing and/or demand pricing) for two or more periods (e.g., four periods) (time and/or price), sequences instructions from one or more utility companies for when to perform charging, and/or past/present/future demand on the one or more electric grids providing electricity to electric vehicle charging station 101, information about any fuel mixes (e.g., 40 percent (%) coal, 30% natural gas, etc.) utilized in generating any energy made available by the one or more utility companies, and the like. Meanwhile, transformer distribution data can comprise data referring to a total quantity of electric vehicle charging stations coupled to a local transformer (e.g., a residential transformer) to which electric vehicle charging station 101 is coupled as well as a predetermined electric load tolerance (e.g., a maximum electric load tolerance) of the local transformer and further referring to a demand quantity of the total quantity of electric vehicle charging stations coupled to the transformer that are presently demanding electricity therefrom (e.g., the electricity being made available to the transformer by the electric grid(s) of which the transformer is a part). In the same or different embodiments, alternative energy resource data can be similar to energy and demand data as applied to alternative energy-based resources (e.g., solar, wind, thermal, nuclear, tidal, etc.). In the same or different embodiments, the availability of the electric vehicle charging station data can comprise times and dates when electric vehicle charging station 101 is available for use by user 150 (i.e. times and dates when electric vehicle charging station 101 is not reserved for use by a user other than user 150). In the same or different embodiments, supplementary load data can comprise data referring to local loads (e.g., appliances, etc.) on a local electric grid (e.g., a home and/or commercial electrical system) to which electric vehicle charging station 101 is coupled. In the same or different embodiments, electric vehicle range history data can comprise historical data on one or more distances vehicle 103 has traveled for one or more levels of charge of rechargeable energy storage system 102.

For example, in one scenario, user 150 selects the first charging mode to comprise the at least one day and time by which to complete charging rechargeable energy storage system 102. In this scenario, the charging characteristic of the request to provide the cheapest charge and the data relating to the at least one charging parameter comprises the energy and demand data for one or more electric grids configured to provide the electricity to the electric vehicle charging station, the local transformer distribution data, the alternative energy resource data, the availability of the electric vehicle charging station data, the supplementary load data, and the electric vehicle range history data. Here, input module 106 could reference the energy and demand data and the alternative energy resource data, for example, to determine the present cost of electricity, the electric utility costs for the one or more other periods, and/or the demand data for the one ore more electric grids for any available regular and alternative energy electric resources. Meanwhile, input module 106 could also reference the availability of electric vehicle charging station 101 to determine dates and times during which electric vehicle charging station 101 is available to make available electricity to rechargeable energy storage system 102. Using this information, input module 106 can calculate what possible strategies exist, if any, by which to make available the quantity of the electricity and/or the direction of the electricity to rechargeable energy storage system 102 with electric vehicle charging station 101 by the at least one day and time of the first charging mode. If input module 106 determines multiple possible strategies by which to make available the quantity of the electricity and/or the direction of the electricity, input module 106 can then proceed to calculate which of those strategies will result in the cheapest charge, as prescribed by the present charging characteristic. Accordingly, user interface 105 could then command electric vehicle charging station 101 to make available the quantity of the electricity and/or the direction of the electricity according to this strategy. Alternatively, if input module 106 determines no strategies exist to make available the quantity of the electricity and/or the direction of the electricity to rechargeable energy storage system 102 with electric vehicle charging station 101 by the at least one day and time of the first charging mode, user interface 105 could simply instruct user 150 to provide a new (i.e., second) charging mode. Input module 106 could then repeat the same process it performed for the first charging mode to search for feasible strategies. In many embodiments, this approach could be repeated until a suitable charging mode is provided by user 150. In various embodiments, user 150 can select multiple charging modes at one time such that input module 106 can calculate strategies for each charging mode and determine the best strategy of the multiple charging mode for achieving the charging mode according to the charging characteristic.

In the same examples, the strategies calculated by input module 106 can incorporate energy arbitrage into its calculations based on the energy and demand data and/or alternative energy resource data to arrive at the calculated costs for each strategy (i.e., input module 106 can factor in a cost savings for selling electricity to the electric grid (i.e., a utility company) during certain periods of the electricity transfer duration and for buying electricity from the electric grid (e.g., the utility company) during other periods of the electricity transfer duration).

In the same examples, input module 106 could further reference the supplemental load data to determine when other appliances are in use at, for example, the residence of user 150. Accordingly, input module 106 can calculate its strategies around times of peak load at the residence (e.g., when running a washer, dryer, oven, etc.) in order to further optimize the cost efficiency of the charge.

Meanwhile, in further examples, input module 106 could reference and incorporate the local transformer distribution data into its calculations to anticipate the present electric load on the local transformer based on the demand quantity of the total quantity of electric vehicle charging stations (e.g., calculating the present electric load), as described above. Accordingly, input module 106 can calculate its strategies so as to sequence charging at each of the electric vehicle charging stations (including electric vehicle charging station 101) coupled to the local transformer such that the anticipated present electric load on the local transformer does not exceed the maximum electric load tolerance of the local transformer.

In some examples, input module 106 may be able to calculate more strategies when the charging characteristic comprises a request for a cleanest charge if using alternative energy resources increases the amount of electricity available to electric vehicle charging station 101.

Various other examples where the first charging mode and/or the charging characteristic differ from those examples provided above can be substantially similar in approach to those examples provided. In some examples, if the charging characteristic comprises the request to provide the environmentally cleanest charge, input module 106 can rely more greatly on references to the alternative energy resource data. Likewise, for examples where the first charging mode comprises at least one percentage of a maximum charge capacity of rechargeable energy storage system 102 to which to charge rechargeable energy storage system 102 and the charging characteristic comprises the request to provide the fastest charge, input module 106 can rely less on extraneous information such as the supplemental load data because, in such a scenario, avoiding peak energy times would be irrelevant. In still other examples, where the first charging mode comprises at least one distance user 150 desires to travel, input module 106 can reference the electric vehicle range history data to more accurately pinpoint a particular quantity of electricity that vehicle 103 may require to travel the desired distance (one-way or round trip).

In many embodiments, the quantity of the electricity and/or the direction of the electricity provided by electric vehicle charging station 101 comprises a first quantity of the electricity and/or a first direction of the electricity. In the same or different embodiments, input module 106 can be configured to monitor the data relating to the at least one charging parameter in accordance with the charging characteristic while electric vehicle charging station 101 provides the first quantity of the electricity and/or the first direction of the electricity to determine if at least one of a second quantity of the electricity and/or a second direction of the electricity better achieves the first charging mode as prescribed by the charging characteristic than the first quantity of the electricity and/or the first direction of the electricity. For example, input module 106 can continue performing calculations similar to the calculations described above throughout the duration of the electricity transfer to dynamically optimize the current strategy being used by electric vehicle charging station 101 to make available the quantity of the electricity and/or the direction of the electricity to rechargeable energy storage system 102. Accordingly, user interface 105 can be configured to provide updated commands to electric vehicle charging station 101 to ensure rechargeable energy storage system 102 is receiving electricity according to the presently optimal strategy provided by input module 106.

In many embodiments, user interface 105 can be configured to permit user 150 to select the first charging mode and/or the charging characteristic by storing one or more charging modes (e.g., the user inputs, etc.) and/or charging characteristics/charging characteristic rankings as part of user profile 151 of user 150 such that control system 100 and/or user interface 105 automatically receive the first charging mode and/or the charging characteristic when user interface 105 authenticates user 150. In some embodiments, user profile 151 can be stored as part of computer database 116 at one or more storage modules of computer system 117. Computer database 116 can be similar to any of computer database(s) 111, and/or computer system 117 can be similar or identical to computer system 400 (FIG. 4), as describe below. Likewise, computer system 117 can be configured to communicate with computer system(s) 115, and vice versa. In many embodiments, computer database 116 and/or computer system 117 can be maintained and/or operated by the operator of control system 100 and/or the operator of the charging network comprising electric vehicle charging station 101, as described above. In another embodiments, computer system(s) 115 and computer system 117 can be implemented and/or part of the same computer system as opposed to being implemented as separate computer systems. Accordingly, in these embodiments, computer database(s) 111 and computer database 116 can all be located at and/or stored at this same computer system.

In the same or different embodiments, user 150 can become a member of the charging network, described above. In some embodiments, when user 150 becomes a member, the user 150 can establish user profile 151 to streamline the charging process. In the same or different embodiments, users can become members of the network by providing a one-time and/or a recurring fee or in some examples, at no cost. In the same or different embodiments, user interface 105 can authenticate user 150 via one or more of a pass code, radio frequency identification, optical recognition, magnetic card identification, fingerprint identification, etc.

In some embodiments, computer system 117 can operate as a centralized computer system for implementing part of control system 100 in addition to storing computer database 116 (i.e., user profile 151). In these embodiments, one or more of data acquisition module 110, input module 106, and/or prediction module 113, as described below, can be part of and/or located at computer system 117. Accordingly, in these embodiments, user interface 105 can communicate with any of data acquisition module 110, input module 106, and/or prediction module 113 remotely when data acquisition module 110, input module 106, and/or prediction module 113 are part of and/or located at computer system 117 such that user interface 105 operates as a front end (e.g., for communicating with user 150) of control system 100 and computer system 117 operates as a back end (e.g., to implement the functionalities of one or more of data acquisition module 110, input module 106, and/or prediction module 113) of control system 100.

Referring back to FIG. 1, in some embodiments, user interface 105 (e.g., terminal) is located at and/or is part of electric vehicle charging station 101. Meanwhile, computer system 115, computer database(s) 111, computer system 117, and/or computer database 116 can be at one or more locations remote from electric vehicle charging station 101. In other embodiments, user interface 105 (e.g., personal computer and/or mobile device) is at a first location remote from electric vehicle charging station 101, and computer system 115, computer database(s) 111, computer system 117, and/or computer database 116 can be at one or more second locations remote from electric vehicle charging station 101. In the same or different embodiments, data acquisition module 110 and input module 106 can be part of electric vehicle charging station 101 and/or user interface 105.

In some embodiments, user interface 105 and/or control system 100 can further comprise prediction module 113 configured to receive the charging mode, the charging characteristic, and the charging parameter, and to calculate a prediction as to the cost to charge rechargeable energy storage system 102 for each day and time of the at least one day and time by which to complete charging rechargeable energy storage system 102. In many embodiments, prediction module 113 can further be configured to calculate a prediction as to the cost to charge rechargeable energy storage system 102 for any other charging mode. For example, in some embodiments, prediction module 113 can reference the charging parameter data for energy and demand data to determine present and/or future costs/values of electricity, and can use the present and/or future costs/values of electricity to calculate an estimated cost to charge rechargeable energy storage system 102 for each strategy provided by input module 106, as described above with respect to input module 106.

In some embodiments, electric vehicle charging station 101, user interface 105 and/or control system 100 can further comprise a timing module. The timing module can be part of or can be separate from electric vehicle charging station 101 and/or user interface 105. The timing module can comprise a clock and/or a timer. The timing module can be configured to communicate with user interface 105, data acquisition module 110, input module 106, and/or prediction module 113 to provide a clock time or a passage of an interval of time, as applicable, to perform their respective functions. For example, user interface 105 and/or input module 106 can communicate with the timing module when the user selects a first charging mode comprising the at least one day and time by which to complete charging rechargeable energy storage system 102 and/or the at least one duration of time during which to charge rechargeable energy storage system 102 to obtain time conditions to perform one or more of these charges. Data acquisition module 110 can communicate with the timing module to correlate the data relating to the at least one charging parameter to time conditions and/or prediction module 113 can communicate with the timing module to obtain time conditions to enable prediction module 113 to calculate predictions of cost for any of charging mode (e.g., where the calculation requires one or more time-based components).

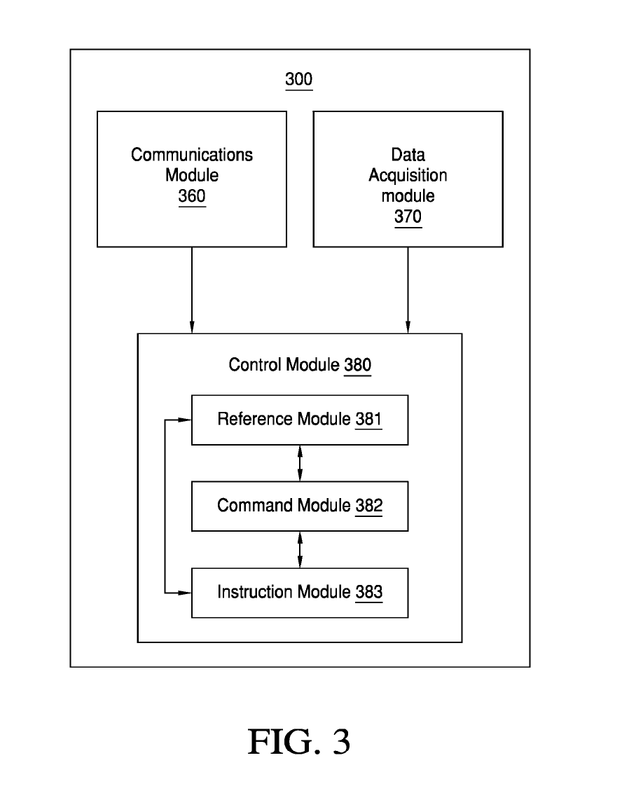

Skipping ahead in the drawings, FIG. 3 illustrates a block diagram of control system 300 for an electric vehicle charging station to charge a rechargeable energy storage system. Control system 300 is configured to be run on one or more processors of computer system 400 and storable in one or more memory units of computer system 400, according to an embodiment of control system 300. In some embodiments, the electric vehicle charging station and/or the rechargeable energy storage system can be similar to electric vehicle charging station 101 (FIG. 1) and/or rechargeable energy storage system 102 (FIG. 1), respectively. Control system 300 is merely exemplary and is not limited to the embodiments presented herein. Control system 300 can be employed in many different embodiments or examples not specifically depicted or described herein. In the same or different embodiments, any elements of system 300 can be similar to like numbered elements of control system 300.

In many embodiments, any single module/sub-module or combination of modules/sub-modules of control system 300 can comprise hardware and/or software. In the same or different embodiments, where any single module/sub-module or combination of modules/sub-modules of control system 300 comprises hardware and/or software, that module or those modules of control system 300 can further be combined with an additional module/sub-module or multiple modules/sub-modules of hardware and/or software of a system other than control system 300.

In many embodiments, any single module/sub-module or combination of modules/sub-modules of control system 300 can be configured to communicate with any other single module/sub-module or combination of modules/sub-modules of control system 300. In the same or different embodiments, where any single module/sub-module or combination of modules/sub-modules of control system 300 is configured to communicate with any other single module/sub-module or combination of modules/sub-modules of control system 300, communication can comprise passing information between the any single module/sub-module or combination of modules/sub-modules of control system 300 and the any other single module/sub-module or combination of modules/sub-modules of control system 300.

In many embodiments, control system 300 can be configured to operate in real time. In the same or different embodiments, at least one module and/or sub-module in control system 300 can be configured to perform an operation upon the occurrence of an operation by at least one of or a combination of the other modules of control system 300. In the same or different embodiments, at least one module and/or sub-module in control system 300 can be configured to perform an operation upon the occurrence of an operation by a combination of the other modules of control system 300 when the other modules operate in a specified sequence. In still other embodiments, at least one module and/or sub-module in control system 300 can be configured to operate upon the passage of a certain interval of time.

In some embodiments, control system 300 can comprise a public system. In many embodiments, where control system 300 comprises a public system, control system 300 can comprise at least one of a government public system or a commercial public system (including a non-profit public system). In some embodiments, where control system 300 comprises a public system, control system 300 can be operated for free or for a fee. In other embodiments, control system 300 can comprise a private system. In many embodiments, where control system 300 comprises a private system, control system 300 can comprise at least one of a domestic private system or a commercial private system (including a non-profit private system). In various embodiments, where control system 300 comprises at least one of a domestic private system or a commercial private system, control system 300 can be privately leased or owned. Additional details of control system 300 are described below.

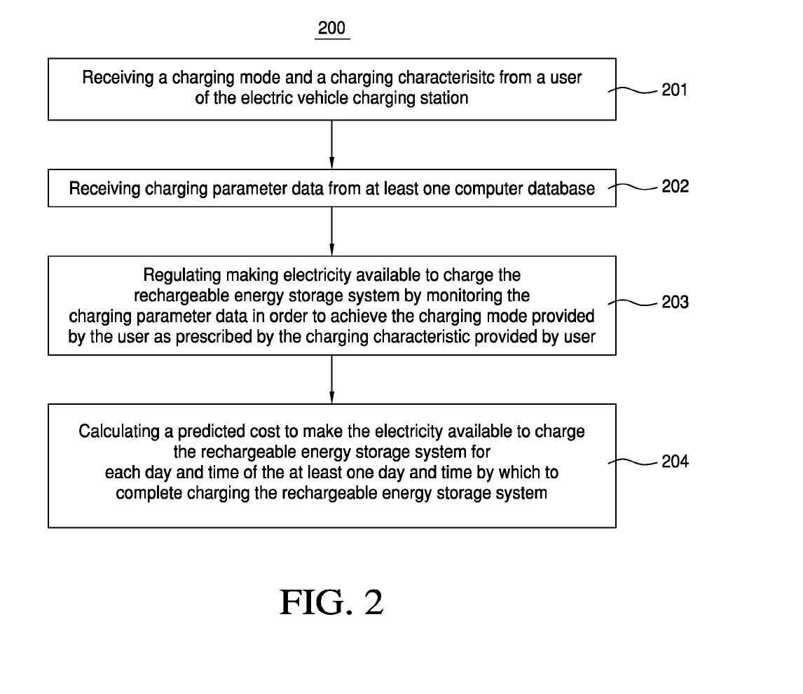

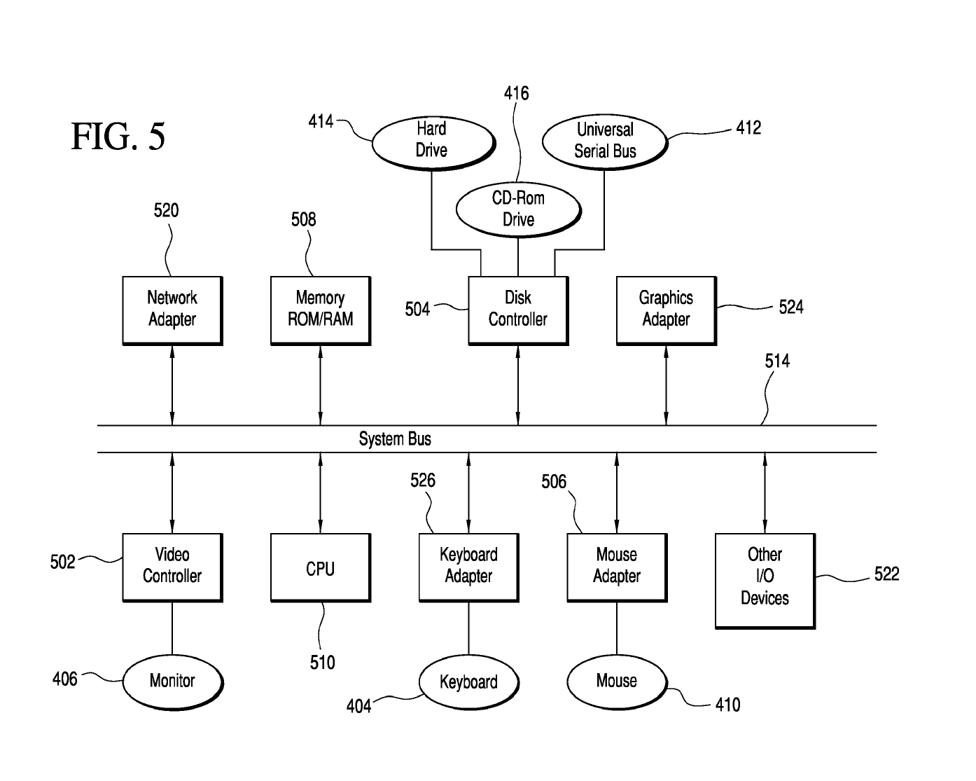

Turning to the next figure, FIG. 4 illustrates an exemplary embodiment of computer 400 that can be suitable for implementing at least part of methods 200 and/or 600 (FIGS. 2 & 6) and one or more functions of control system 100 and/or control system 300 (FIGS. 1 & 3). Computer system 400 includes chassis 402 containing one or more circuit boards (not shown), Universal Serial Bus (USB) 412, Compact Disc Read-Only Memory (CD-ROM) and/or Digital Video Disc (DVD) drive 416, and hard drive 414. A representative block diagram of the elements included on the circuit boards inside chassis 402 is shown in FIG. 5. Central processing unit (CPU) 510 in FIG. 5 is coupled to system bus 514 in FIG. 5. In various embodiments, the architecture of CPU 510 can be compliant with any of a variety of commercially distributed architecture families. System bus 514 also is coupled to memory 508, where memory 508 includes both read only memory (ROM) and random access memory (RAM). Non-volatile portions of memory 508 or the ROM can be encoded with a boot code sequence suitable for restoring computer 400 (FIG. 4) to a functional state after a system reset. In addition, memory 508 can include microcode such as a Basic Input-Output System (BIOS). In some examples, the memory unit of the various embodiments disclosed herein can include memory 508, USB 412 (FIGS. 4-5), hard drive 414 (FIGS. 4-5), and/or CD-ROM or DVD drive 416 (FIGS. 4-5). In the same or different examples, the memory unit of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Examples of common operating systems can include Microsoft® Windows, Mac® operating system (OS), UNIX® OS, and Linux® OS. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

As used herein, “processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the depicted embodiment of FIG. 5, various I/O devices such as disk controller 504, graphics adapter 524, video controller 502, keyboard adapter 526, mouse adapter 506, network adapter 520, and other I/O devices 522 can be coupled to system bus 514. Keyboard adapter 526 and mouse adapter 506 are coupled to keyboard 404 (FIGS. 4-5) and mouse 410 (FIGS. 4-5), respectively, of computer 400 (FIG. 4). While graphics adapter 524 and video controller 502 are indicated as distinct units in FIG. 5, video controller 502 can be integrated into graphics adapter 524, or vice versa in other embodiments. Video controller 502 is suitable 730293 26 for refreshing monitor 406 (FIGS. 4-5) to display images on a screen 408 (FIG. 4) of computer 400 (FIG. 4). Disk controller 504 can control hard drive 414 (FIGS. 4-5), USB 412 (FIGS. 4-5), and CD-ROM drive 416 (FIGS. 4-5). In other embodiments, distinct units can be used to control each of these devices separately.

In some embodiments, network adapter 520 can be part of a WNIC (wireless network interface controller) card (not shown) plugged or coupled to an expansion port (not shown) in computer 400. In other embodiments, the WNIC card can be a wireless network card built into computer system 400. A wireless network adapter can be built into computer system 400 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 520 can be a wired network adapter.

Although many other components of computer 400 (FIG. 4) are not shown, such components and their interconnection are well known to those of ordinary skill in the art. Accordingly, further details concerning the construction and composition of computer 400 and the circuit boards inside chassis 402 (FIG. 4) are not discussed herein.

When computer system 400 in FIG. 4 is running, program instructions stored on a USB equipped electronic device connected to USB 412, on a CD-ROM or DVD in CD-ROM and/or DVD drive 416, on hard drive 414, or in memory 508 (FIG. 5) are executed by CPU 510 (FIG. 5). A portion of the program instructions, stored on these devices, can be suitable for carrying out at least part of methods 200 and/or 600 (FIGS. 2 & 6) and one or more functions of control system 100 and/or control system 300 (FIGS. 1 & 3).

Although computer system 400 is illustrated as a desktop computer in FIG. 4, there can be examples where computer system 400 may take a different form factor while still having functional elements similar to those described for computer system 400. In some embodiments, computer system 400 may comprise a single computer, a single server, or a cluster or collection of computers or servers, or a cloud of computers or servers. Typically, a cluster or collection of servers can be used when the demands by client computers are beyond the reasonable capability of a single server or computer. In many embodiments, the servers in the cluster or collection of servers are interchangeable from the perspective of the client computers.

In some examples, a single server can include modules to perform various methods, procedures, processes, and activities. In other examples, a first server can include a first portion of these modules. One or more second servers can include a second, possibly overlapping, portion of these modules. In these examples, the computer system can comprise the combination of the first server and the one or more second servers.

Referring now back to FIG. 3, control system 300 comprises communications module 360 configured to be run on the one or more processor. In the same or different embodiments, communications module 360 is configured to receive one or more charging modes (e.g., a first charging mode, a second charging mode, etc.) from a user of the electric vehicle charging station and/or a user profile of the user of the electric vehicle charging station and/or a charging characteristic. In the same or different embodiments, the user and/or the user profile can be similar to user 150 (FIG. 1) and/or user profile 151 (FIG. 1), respectively. In the same or different embodiments, the one or more charging modes and/or the charging characteristic can be similar to the one or more charging modes and/or charging characteristic of control system 100 (FIG. 1). In some embodiments, the user provides the charging characteristic.

Referring again to FIG. 3, control system 300 comprises data acquisition module 370 configured to be run on the one or more processors. In the same or different embodiments, data acquisition module 370 is configured to receive data relating to at least one charging parameter from at least one computer database. In the same or different embodiments, the at least one computer database can be similar to computer database(s) 111 (FIG. 1). In the same or different embodiments, the data relating to the at least one charging parameter can be similar to the data relating to the at least one charging parameter described above with respect to control system 100 (FIG. 1). In some embodiments, control system 300 can comprise the at least one computer database. In other embodiments, the at least one computer database can be separate from control system 300.

Referring again to FIG. 3, data acquisition module 370 is configured to acquire the data relating to the at least one charging parameter from the at least one computer database through a remote computer network connection. In the same or different embodiments, the remote computer network connection can be similar to the connection to computer network 112 (FIG. 1). In some embodiments, data acquisition module 370 acquires the data relating to the at least one charging parameter as established by the user of the electric vehicle charging station and/or the user profile of the user. For example, data acquisition module 370 can be configured to provide a menu from which the user can select the at least one charging parameter. In other examples, data acquisition module 370 can be configured to automatically acquire the at least one charging parameter as pre-selected by the user in the user profile upon receiving an authentication from the user. In other embodiments, data acquisition module 370 acquires the data relating to the at least one charging parameter as established by the charging characteristic. For example, in some embodiments, when the charging characteristic comprises a request for a fastest charge, data acquisition module 370 can acquire data relating to the at least one charging parameter that omits supplemental load data, but includes other exemplary data relating to the at least one charging parameter because the supplemental load data may not provide substantially useful information for control module 380 compared to the other exemplary data relating to the at least one charging parameter, as described below, to justify an increased calculation time resulting from including the supplemental load data in the calculations performed by reference module 381, as described below.

Referring to FIG. 3, control system 300 comprises control module 380 configured to be run on the one or more processors. In the same or different embodiments, control module 380 is configured to receive the first charging mode and/or the charging characteristic from communications module 360, and the data relating to the at least one charging parameter from data acquisition module 370. In the same or different embodiments, control module 380 is configured to control the electric vehicle charging station by making available a quantity of the electricity passing between the electric vehicle charging station and the rechargeable energy storage system and/or a direction of the electricity passing between the electric vehicle charging station and the rechargeable energy storage system.

Referring to FIG. 3, control system 300 and/or control module 380 can comprise reference module 381. Reference module 381 is configured to reference the at least one charging parameter in accordance with the charging characteristic to determine if the electric vehicle charging station is able to make available the quantity of the electricity and the direction of the electricity to achieve the first charging mode.

Referring to FIG. 3, control system 300 and/or control module 380 can comprise command module 382. Command module 382 is configured to command the electric vehicle charging station to provide the quantity of the electricity and the direction of the electricity that achieves the first charging mode provided by the user of the electric vehicle charging station and/or the user profile of the user when reference module 381 determines that the electric vehicle charging station is able to make available the quantity of the electricity and the direction of the electricity to achieve the first charging mode.

Control system 300 and/or control module 380 can also comprise instruction module 383. Instruction module 383 is configured to provide the user with instructions to provide the second charging mode to communications module 360 when reference module 381 determines that the electric vehicle charging station is not able to make available the quantity of the electricity and the direction of the electricity to achieve the first charging mode.

In many embodiments, the quantity of the electricity and the direction of the electricity provided by the electric vehicle charging station can comprise a first quantity of the electricity and/or a first direction of the electricity. In the same or different embodiments, control module 380 is configured to monitor the data relating to the at least one charging parameter in accordance with the charging characteristic while the electric vehicle charging station provides the first quantity of the electricity and/or the first direction of the electricity to determine if at least one of a second quantity of the electricity and/or a second direction of the electricity better achieves the first charging mode as prescribed by the charging characteristic than the first quantity of the electricity and/or the first direction of the electricity.

In various embodiments, reference module 381 and/or control module 380 can be configured to operate similarly to input module 106 (FIG. 1) and/or user interface 105 (FIG. 1), respectively, as described above.

In some embodiments, control module 380 can further comprise a timing module. The timing module can comprise a clock and/or a timer. The timing module can be configured to communicate with reference module 381, command module 382, and/or instruction module 383 to provide a clock time or a passage of an interval of time, as applicable, to perform their respective functions. The timing module can be configured to operate similarly to the timing module described above with respect to control system 100 (FIG. 1).

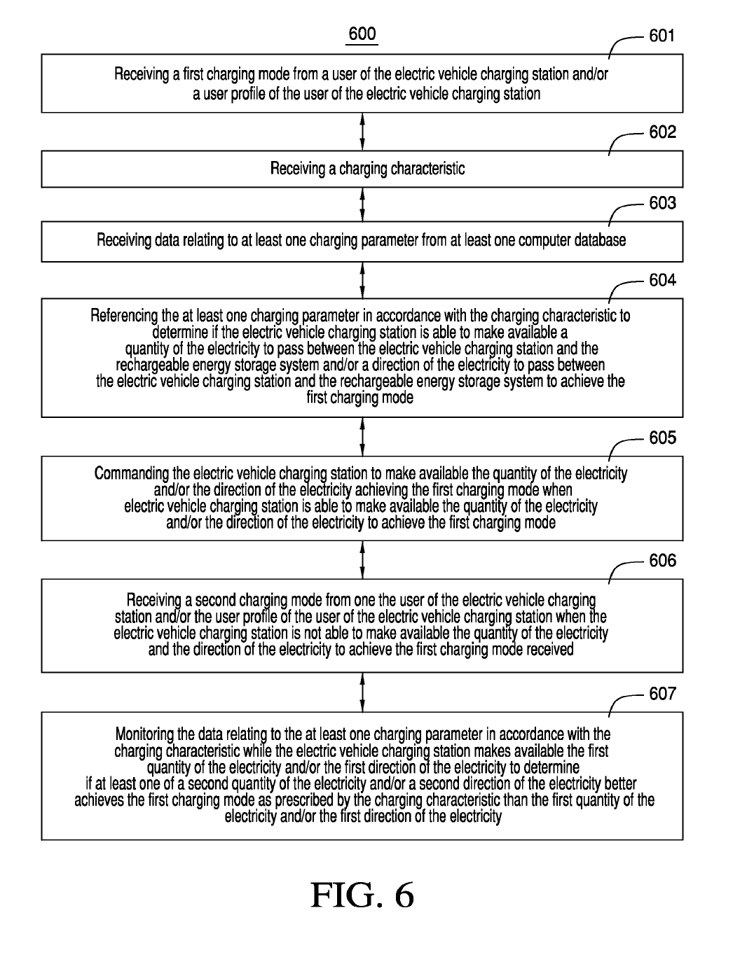

FIG. 6 illustrates a flow chart for an embodiment of method 600 for operating an electric vehicle charging station to charge a rechargeable energy storage system. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, procedures, the processes, and/or the activities of the method 600 can be performed in any other suitable order. In still other embodiments, one or more of procedures, the processes, and/or the activities in method 600 can be combined or skipped.

In many embodiments, method 600 can be configured to operate in real time. In the same or different embodiments, at least one procedure, process, or activity in method 600 can occur upon the occurrence of an operation by at least one of or a combination of the other procedures, processes, or activities of method 600. In the same or different embodiments, at least one procedure, process, or activity in method 600 can occur upon the occurrence of an operation by a combination of the other procedures, processes, or activities of method 600 when the other procedures, processes, or activities of method 600 occur in a specified sequence. In still other embodiments, at least one procedure, process, or activity in method 600 can be configured to occur upon the passage of a certain interval of time.

Referring now to FIG. 6, method 600 comprises procedure 601 of receiving a first charging mode from a user of the electric vehicle charging station and/or a user profile of the user of the electric vehicle charging station. In the same or different embodiments, the first charging mode can be similar to the first charging mode described above with respect to control system 100. In the same or different embodiments, the user can be similar to user 150 (FIG. 1). In the same or different embodiments, the user profile can be similar to user profile 151 (FIG. 1). In the same or different embodiments, the electric vehicle charging station and/or rechargeable energy storage system can be similar to electric vehicle charging station 101 (FIG. 1) and/or rechargeable energy storage system 102 (FIG. 1) respectively. In some embodiments, procedure 601 can comprise receiving a first charging mode from a user of the electric vehicle charging station and/or a user profile of the user of the electric vehicle charging station via a user interface similar to user interface 105 (FIG. 1).

Referring back to FIG. 6, method 600 comprises procedure 602 of receiving a charging characteristic. In the same or different embodiments, the charging characteristic can be similar to the charging characteristic describe above with respect to control system 100 (FIG. 1). In some embodiments, procedure 602 can comprise receiving the charging characteristic from the user and/or the user profile. In the same or different embodiments, procedure 602 can comprise receiving the charging characteristic from the user and/or the user profile via the user interface. In other embodiments, procedure 602 can comprise establishing the charging characteristic according to data relating to at least one charging parameter, as described below with respect to procedure 603.

Referring to FIG. 6, method 600 comprises procedure 603 of receiving data relating to at least one charging parameter from at least one computer database. In the same or different embodiments, the data relating to the at least one charging parameter can be similar to the data relating to the at least one charging parameter as described above with respect to control system 100 (FIG. 1). In various embodiments, the at least one computer database can be similar to computer database(s) 111 (FIG. 1). In some embodiments, procedure 603 can comprise communicating with the at least one computer database via a remote computer network connection. In the same or different embodiments, the remote computer network connection can be similar to the connection to computer network 112 (FIG. 1).

Referring to FIG. 6, method 600 comprises procedure 604 of referencing the at least one charging parameter in accordance with the charging characteristic to determine if the electric vehicle charging station is able to make available a quantity of the electricity to pass between the electric vehicle charging station and the rechargeable energy storage system and/or a direction of the electricity passing between the electric vehicle charging station and the rechargeable energy storage system to achieve the first charging mode. For example, performing procedure 604 can be similar to the examples described above with respect to input module 106 (FIG. 1).

Referring to FIG. 6, method 600 comprises procedure 605 of commanding the electric vehicle charging station to make available the quantity of the electricity and/or the direction of the electricity achieving the first charging mode when the electric vehicle charging station is able to make available the quantity of the electricity and/or the direction of the electricity to achieve the first charging mode.

Referring to FIG. 6, method 600 comprises procedure 606 of receiving a second charging mode from one the user of the electric vehicle charging station and/or the user profile of the user of the electric vehicle charging station when the electric vehicle charging station is not able to make available the quantity of the electricity and the direction of the electricity to achieve the first charging mode received. In the same or different embodiments, the second charging mode can be similar to the second charging mode described above with respect to control system 100 (FIG. 1). For example, performing procedure 606 can be similar to the examples described above with respect to input module 106 (FIG. 1).

In many embodiments, the quantity of the electricity and the direction of the electricity provided by the electric vehicle charging station can comprise a first quantity of the electricity and/or a first direction of the electricity. Referring to FIG. 6, in the same or different embodiments, method 600 can comprise procedure 607 of monitoring the data relating to the at least one charging parameter in accordance with the charging characteristic while the electric vehicle charging station makes available the first quantity of the electricity and/or the first direction of the electricity to determine if at least one of a second quantity of the electricity and/or a second direction of the electricity better achieves the first charging mode as prescribed by the charging characteristic than the first quantity of the electricity and/or the first direction of the electricity. For example, performing procedure 607 can be similar to the examples described above with respect to input module 106 (FIG. 1).

FIG. 2 illustrates a flow chart for an embodiment of method 200 for operating an electric vehicle charging station configured to communicate with at least one computer database. Method 200 is merely exemplary and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, procedures, the processes, and/or the activities of the method 200 can be performed in any other suitable order. In still other embodiments, one or more of procedures, the processes, and/or the activities in method 200 can be combined or skipped.

In many embodiments, method 200 can be configured to operate in real time. In the same or different embodiments, at least one procedure, process, or activity in method 200 can occur upon the occurrence of an operation by at least one of or a combination of the other procedures, processes, or activities of method 200. In the same or different embodiments, at least one procedure, process, or activity in method 200 can occur upon the occurrence of an operation by a combination of the other procedures, processes, or activities of method 200 when the other procedures, processes, or activities of method 200 occur in a specified sequence. In still other embodiments, at least one procedure, process, or activity in method 200 can be configured to occur upon the passage of a certain interval of time.

Referring now to FIG. 2, method 200 comprises procedure 201 of receiving a charging mode and a charging characteristic from a user of the electric vehicle charging station. In the same or different embodiments, the charging mode and/or the charging characteristic can be similar to the charging mode and/or charging characteristic as described above with respect to control system 100. In the same or different embodiments, the user can be similar to user 150 (FIG. 1), and the electric vehicle charging station can be similar to electric vehicle charging station 101 (FIG. 1).

Referring back to FIG. 2, method 200 comprises procedure 202 of receiving charging parameter data from the at least one computer database. In the same or different embodiments, charging parameter data can be similar to the charging parameter data described above with respect to system 100 (FIG. 1). In the same or different embodiments, the at least one computer database can be similar to computer database(s) 111 (FIG. 1). In some embodiments, procedure 202 can comprise communicating with the at least one computer database via a remote computer network connection. In the same or different embodiments, the remote computer network connection can be similar to the connection to computer network 112 (FIG. 1).

Referring again to FIG. 2, method 200 comprises procedure 203 of regulating making electricity available to charge the rechargeable energy storage system by monitoring the charging parameter data in order to achieve the charging mode provided by the user as prescribed by the charging characteristic provided by the user. In the same or different embodiments, the electric vehicle power system can be similar to electric vehicle power system 102 (FIG. 1). For example, performing procedure 203 can be similar to the examples described above with respect to input module 106 (FIG. 1).

Referring back to FIG. 2, method 200 can comprise procedure 204 of calculating a predicted cost to make the electricity available to charge the rechargeable energy storage system for each day and time of the at least one day and time by which to complete charging the rechargeable energy storage system. For example, performing procedure 204 can be similar to the examples described above with respect to prediction module 113 (FIG. 1).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 601-607 and procedures 201-204 may be comprised of many different procedures, processes, and/or activities and be performed by many different modules, in many different orders, that any element of FIGS. 1-6 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A system for charging a rechargeable energy storage system of an electric vehicle, the system comprising:
an electric vehicle charging station configured to make available electricity to charge the rechargeable energy storage system of the electric vehicle;
a user interface configured to receive a charging mode and a charging characteristic and to communicate with the electric vehicle charging station in order to operate the electric vehicle charging station;
a data acquisition module configured to communicate with the user interface and to receive charging parameter data;
and
a control module configured (a) to communicate with the user interface and the data acquisition module, (b) to receive the charging mode, the charging characteristic, and the charging parameter data, (c) to monitor in real time the charging parameter data, and (d) based on the charging parameter data, to control when the electric vehicle charging station makes available the electricity to charge the rechargeable energy storage system in order to achieve the charging mode in view of the charging characteristic;
wherein:
the charging mode comprises a day and time by which to complete charging the rechargeable energy storage system;
the charging characteristic comprises at least one of a request to provide a fastest charge, a request to provide a cheapest charge, or a request to provide an environmentally cleanest charge; and
the charging parameter data comprises at least one of energy and demand data for one or more electric grids configured to provide the electricity to the electric vehicle charging station, alternative energy resource data, or availability of the electric vehicle charging station data.

2) The system of claim 1 wherein:
the user interface is configured to receive the charging mode and the charging characteristic from at least one of a user of the electric vehicle charging station or a user profile of the user.

3) The system of claim 2 wherein:
the user interface is configured to communicate with a computer system comprising a computer database, the computer database comprising the user profile.

4) The system of claim 3 further comprising:
the computer system.

5) The system of claim 1 wherein at least one of:
the user interface comprises one of a personal computer, a mobile device, or a terminal, the electric vehicle charging station comprising the terminal;
at least one of the electric vehicle charging station or the user interface comprises the control module; or
at least one of the electric vehicle charging station or the user interface comprises the data acquisition module.

6) The system of claim 1 wherein:
the data acquisition module is configured to receive the charging parameter data in real time via communication with a computer system comprising at least one computer database, the at least one computer database comprising the charging parameter data, and the computer system being located remotely from the electric vehicle charging station.

7) The system of claim 6 wherein:
the computer system is operated by at least one utility company.

8) The system of claim 6 further comprising:
the computer system.

9) The system of claim 1 further comprising:
a prediction module configured (a) to communicate with the user interface and the data acquisition module, (b) to receive the charging mode, the charging characteristic, and the charging parameter data, and (c) based on the charging parameter data, to calculate a prediction as to a cost to charge the rechargeable energy storage system by the day and time of the charging mode.

10) The system of claim 1 wherein:
the charging parameter data further comprises at least one of:
supplementary load data; or
electric vehicle range history data of the electric vehicle.

11) The system of claim 1 wherein:
the charging characteristic comprises two or more ranked ones of the at least one of the request to provide the fastest charge, the request to provide the cheapest charge, or the request to provide the environmentally cleanest charge.

12) The system of claim 1 wherein:
the user interface is configured to automatically receive the charging mode and the charging characteristic when the user interface authenticates the user of the electric vehicle charging station.

13) A system for charging a rechargeable energy storage system of an electric vehicle, the system comprising:
an input module configured to receive a charging mode and a charging characteristic and to communicate with an electric vehicle charging station in order to operate the electric vehicle charging station, the electric vehicle charging station being configured to make available electricity to charge the rechargeable energy storage system of the electric vehicle;
a data acquisition module configured to communicate with the input module and to receive charging parameter data;
and
a control module configured (a) to communicate with the input module and the data acquisition module, (b) to receive the charging mode, the charging characteristic, and the charging parameter data, (c) to monitor in real time the charging parameter data, and (d) based on the charging parameter data, to control when the electric vehicle charging station makes available the electricity to charge the rechargeable energy storage system in order to achieve the charging mode in view of the charging characteristic;
wherein:
the charging mode comprises a day and time by which to complete charging the rechargeable energy storage system;
the charging characteristic comprises at least one of a request to provide a fastest charge, a request to provide a cheapest charge, or a request to provide an environmentally cleanest charge; and
the charging parameter data comprises at least one of energy and demand data for one or more electric grids configured to provide the electricity to the electric vehicle charging station, alternative energy resource data, or availability of the electric vehicle charging station data;
the input module is configured to receive the charging mode and the charging characteristic from at least one of a user of the electric vehicle charging station or a user profile of the user;
at least one of the electric vehicle charging station or the input module comprises the control module;
at least one of the electric vehicle charging station or the input module comprises the data acquisition module; and
the data acquisition module is configured to receive the charging parameter data in real time via communication with a computer system comprising at least one computer database, the at least one computer database comprising the charging parameter data, and the computer system being located remotely from the electric vehicle charging station.

14) A method of making electricity available to charge a rechargeable energy storage system of an electric vehicle by using an electric vehicle charging station, at least part of the method being implemented via execution of computer instructions configured to run at one or more computer processing modules and configured to be stored in one or more non-transitory computer memory storage modules, the method comprising:
receiving a charging mode and a charging characteristic, wherein:
the charging mode comprises a day and time by which to complete charging the rechargeable energy storage system; and
the charging characteristic comprises at least one of a request to provide a fastest charge, a request to provide a cheapest charge, and a request to provide an environmentally cleanest charge;
receiving charging parameter data in real time, the charging parameter data comprising at least one of energy and demand data for one or more electric grids configured to provide the electricity to the electric vehicle charging station, alternative energy resource data, and availability of the electric vehicle charging station data;
monitoring in real time the charging parameter data;
and
based on the charging parameter data, controlling when the electric vehicle charging station makes available the electricity from the electric vehicle charging station to charge the rechargeable energy storage system in order to achieve the charging mode in view of the charging characteristic.

15) The method of claim 14 wherein:
receiving the charging mode and the charging characteristic comprises receiving the charging mode and the charging characteristic from at least one of a user of the electric vehicle charging station or a user profile of the user.

16) The method of claim 14 wherein:
receiving the charging mode and the charging characteristic comprises communicating with a computer system comprising a computer database, the computer database comprising a user profile comprising at least one of the charging mode or the charging characteristic.

17) The method of claim 14 wherein:
receiving the charging parameter data in real time comprises communicating with a computer system comprising at least one computer database, the at least one computer database comprising the charging parameter data, and the computer system being located remotely from the electric vehicle charging station.

18) The method of claim 14 further comprising:
based on the charging parameter data, calculating a prediction as to a cost to charge the rechargeable energy storage system by the day and time of the charging mode.

19) The method of claim 14 wherein:
the charging parameter data further comprises at least one of:
supplementary load data; or
electric vehicle range history data of the electric vehicle.

20) The method of claim 14 wherein:
receiving the charging characteristic comprises receiving a ranked order of two or more of the at least one of the request to provide the fastest charge, the request to provide the cheapest charge, and the request to provide the environmentally cleanest charge.
